(19) United States
(12) Patent Application Publication
(10) Pub. No.: US 2020/0323017 A1
(43) Pub. Date: Oct. 8, 2020

(54) 5G NAS Recovery from NASC Failure

(71) Applicant: MEDIATEK Singapore Pte. Ltd, Singapore (SG)

(72) Inventors: Marko Niemi, Oulu (FI); Jarkko Eskelinen, Oulu (FI)

(21) Appl. No.: 16/842,983

(22) Filed: Apr. 8, 2020

Related U.S. Application Data
(60) Provisional application No. 62/830,634, filed on Apr. 8, 2019.
(60) Provisional application No. 62/969,700, filed on Feb. 4, 2020.

(51) Int. Cl. H04W 76/25; H04W 36/00; H04W 76/30; H04W 12/04; H04W 60/00; H04W 12/06

(52) U.S. Cl. CPC H04W 76/25; H04W 36/0038; H04W 12/06; H04W 12/04031; H04W 60/00; H04W 76/30

(57) ABSTRACT

A method of non-access stratum (NAS) recovery from NAS container (NASC) failure in 5G New Radio (NR) mobile communication network is proposed. The UE performs NAS layer registration and enters 5GMM connected mode in NAS layer through its serving base station. Later on, the UE performs a handover or inter-system change procedure and receives NASC IE from the network. Upon detecting the NASC verification failure, the UE aborts the handover or the inter-system change procedure and goes to IDLE mode. The UE also takes action to synchronize NAS security contexts with the network by triggering a registration procedure for mobility.

### CROSS REFERENCE TO RELATED APPLICATIONS

This application claims priority under 35 U.S.C. § 119 from U.S. Provisional Application No. 62/830,634, entitled “5G NAS N1 Transparent Container Verification Failure Handling”, filed on Apr. 8, 2019; U.S. Provisional Application No. 62/969,700, entitled “5G NAS Recovery from NASC Failure”, filed on Feb. 4, 2020, the subject matter of which is incorporated herein by reference.

### TECHNICAL FIELD

The disclosed embodiments relate generally to wireless communication, and, more particularly, to method of supporting non-access stratum (NAS) recovery from NAS transparent container (NASC) failure in next generation mobile communication systems.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. With the optimization of the network design, many improvements have developed over the evolution of various standards. The Next Generation. Mobile Network (NGMN) board, has decided to focus the future NGMN activities on defining the end-to-end requirements for 5G new radio (NR) systems.

In the core network, an access and mobility function (AMF) serves as termination point for non-access stratum (NAS) security. The AMF can be collocated with a SEcurity Anchor Function (SEAF) that holds the root key (known as anchor key) for the visited network. For mobility management, the AMF initiates a NAS layer security procedure. During handover, NAS aspects that need to be considered are the possible K_{AMF} change, the possible NAS algorithm change, and the possible presence of a parallel NAS connection. There is a possibility that the source AMF and the target AMF do not support the same set of NAS algorithms or have different priorities regarding the use of NAS algorithms. The source to target NAS transparent container IE is an information element that is used to transparently pass radio related information from the handover source to the handover target. In case the K_{AMF} has changed or the target AMF decides to use NAS algorithm different from the ones used by the source AMF, the target AMF shall provide needed parameters to the UE using NAS transparent container (NASC).

According to the current 3GPP specification, if the verification of NASC fails, the UE shall abort the handover procedure. Furthermore, the UE shall discard the new NAS security context if it was derived and continue to use the existing NAS and AS security context. However, such specification does not solve the problem that occurs when NASC verification fails. Because of the NASC verification failure, the UE and the network security context can be out of sync, causing subsequent communication to fail.

A solution is sought.

### SUMMARY

A method of non-access stratum (NAS) recovery from NAS container (NASC) failure in 5G New Radio (NR) mobile communication network is proposed. The UE performs NAS layer registration and enters 5GMM connected mode in NAS layer through its serving base station. Later on, the UE performs a handover or inter-system change procedure and receives NASC IE from the network. Upon detecting the NASC verification failure, the UE aborts the handover or the inter-system change procedure and goes to IDLE mode. The UE also takes action to synchronize NAS security contexts with the network by triggering a registration procedure for mobility.

In one embodiment, a User equipment (UE) establishes a non-access stratum (NAS) signaling connection associated with a NAS security context in a 5G mobile communication network. The UE enters a 5G mobility management (5GMM) connected mode. The UE receives a NAS container (NASC) from the network for a handover procedure. The NASC comprises parameters for UE to handle the NAS security context. The UE detects a NASC verification failure and thereby aborting the handover procedure. The UE releases the NAS signaling connection and entering a 5GMM idle mode in response to the NASC verification failure. The UE transmits a registration request message to trigger a registration procedure with the network and to establish a new NAS security context.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary next generation 5G new radio (NR) network 100 supporting non-access stratum (NAS) recovery from NAS container (NASC) failure in accordance with one novel aspect.

FIG. 2 illustrates simplified block diagrams of a user equipment (UE) and a base station (BS) in accordance with embodiments of the current invention.

FIG. 3 illustrates an example of intra N1 mode NAS transparent container information element (NASC IE) provided by network in intra N1 mode handover.

FIG. 4 illustrates an example of S1 mode to N1 mode NAS transparent container information element (NASC IE) provided by network in inter-system change.

FIG. 5 illustrates a first embodiment of a method for NAS recovering from NASC failure in a next generation 5G system in accordance with one novel aspect.

FIG. 6 illustrates a second embodiment of a method for NAS recovering from NASC failure in a next generation 5G system in accordance with one novel aspect.

FIG. 7 illustrates a third embodiment of a method for NAS recovering from NASC failure in a next generation 5G system in accordance with one novel aspect.

FIG. 8 is a flow chart of a method for NAS recovering from NASC failure in a next generation 5G system in accordance with a novel aspect.

### DETAILED DESCRIPTION

Reference will now be made in detail to some embodiments of the invention, examples of which are illustrated in the accompanying drawings.

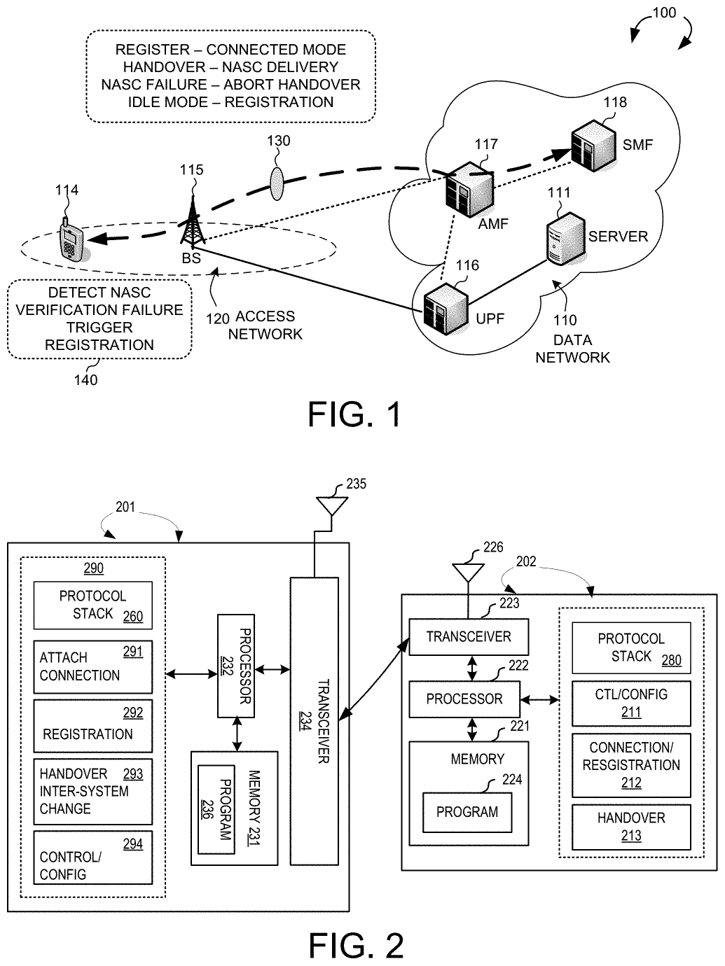

FIG. 1 illustrates an exemplary next generation 5G new radio (NR) network 100 supporting non-access stratum (NAS) recovery from NAS container (NASC) failure in accordance with one novel aspect. NR network 100 comprises data network 110 and application server 111 that provides various services by communicating with a plurality of user equipments (UEs) including UE 114. In the example of FIG. 1, UE 114 and its serving base station gNB 115 belong to part of a radio access network RAN 120. RAN 120 provides radio access for UE 114 via a radio access technology (RAT). Application server 111 communicates with UE 114 through User Plane Function (UPF) 116 and gNB 115. UPF 116 is responsible for routing and forwarding with packet inspection and QoS handling. An access and mobility management function (AMF) 117 communicates with BS 115 for connection and mobility management of wireless access devices in NR network 100. A Session Management Function (SMF) 118 is primarily responsible for interacting with the decoupled data plane, creating, updating and removing Protocol Data Unit (PDU) sessions and managing session context with UPF 116. UE 114 may be equipped with a radio frequency (RF) transceiver or multiple RF transceivers for different application services via different RATs/CNs. UE 114 may be a smart phone, a wearable device, an Internet of Things (IoT) device, and a tablet, etc.

In the core network, the AMF serves as termination point for non-access stratum (NAS) security. The purpose of NAS security is to securely deliver NAS signaling messages between UE and AMF in the control plane using NAS security keys and NAS algorithms. The AMF can be collocated with a SEcurity Anchor Function (SEAF) that holds the root key (known as anchor key) for the visited network. For mobility management, the AMF initiates a NAS layer security procedure. During handover, NAS aspects that need to be considered are the possible K_{AMF} change, the possible NAS algorithm change, and the possible presence of a parallel NAS connection. There is a possibility that the source AMF and the target AMF do not support the same set of NAS algorithms or have different priorities regarding the use of NAS algorithms. In case the K_{AMF} has changed or the target AMF decides to use NAS algorithm different from the ones used by the source AMF, the target AMF shall provide needed parameters to the UE using NAS transparent container (NASC).

According to the current 3GPP specification, if the verification of NASC fails, the UE shall abort the handover procedure. Furthermore, the UE shall discard the new NAS security context if it was derived and continue to use the existing NAS and AS security context. However, such specification does not solve the problem that occurs when NASC verification fails. Because of the NASC verification failure, the UE and the network security context can be out of sync, causing subsequent communication to fail. In accordance with one novel aspect, when the UE detects the NASC verification failure, the UE takes action (140) to synchronize with the network by triggering a registration procedure for mobility. As depicted by 130 of FIG. 1, UE 114 performs NAS layer registration with AMF 117 and enters 5GMM connected mode in NAS layer through its serving gNB 115. Later on, UE 114 performs a handover or inter-system change procedure and receives NASC IE from the network. Upon detecting the NASC verification failure, UE 114 aborts the handover or the inter-system change procedure. UE 114 goes back to 5GMM idle mode and sends a REGISTRATION REQUEST message to AMF 117 to establish new NAS security context for mobility.

FIG. 2 illustrates simplified block diagrams of a user equipment UE 201 and a network entity 202 in accordance with embodiments of the current invention. Network entity 202 can be a gNB or an AMF or both. Network entity 202 may have an antenna 226, which may transmit and receive radio signals. RF transceiver module 223, coupled with the antenna, may receive RF signals from antenna 226, convert them to baseband signals and send them to processor 222. RF transceiver 223 may also convert received baseband signals from processor 222, convert them to RF signals, and send out to antenna 226. Processor 222 may process the received baseband signals and invoke different functional modules to perform features in network entity 202. Memory 221 may store program instructions and data 224 to control the operations of network entity 202. Network entity 202 may also include a set of functional modules and control circuits, such as protocol stack 260, a control and configuration circuit 211 for control and configure mobility to UE, a connection and registration handling circuit 212 for establish connection and registration with UE, and a handover circuit 213 for sending handover and inter-system change commands to UE.

Similarly, UE 201 has an antenna 235, which may transmit and receive radio signals. RF transceiver module 234, coupled with the antenna, may receive RF signals from antenna 235, convert them to baseband signals and send them to processor 232. RF transceiver 234 may also convert received baseband signals from processor 232, convert them to RF signals, and send out to antenna 235. Processor 232 may process the received baseband signals and invoke different functional modules to perform features in the UE 201. Memory 231 may store program instructions and data 236 to control the operations of the UE 201. UE 201 may also include a set of function modules and control circuits that may carry out functional tasks of the present invention. Protocol stacks 260 comprise Non-Access-Stratum (NAS) layer to communicate with an AMF/SMF/MME entity connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. An attach and connection circuit 291 may attach to the network and establish connection with serving gNB, a registration circuit 292 may perform registration with AMF, a handover handling circuit 293 may perform handover or inter-system change, and a control and configuration circuit 294 for control and configure mobility related features.

The various function modules and control circuits may be implemented and configured by software, firmware, hardware, and combination thereof. The function modules and circuits, when executed by the processors via program instructions contained in the memory, interwork with each other to allow the base station and UE to perform embodiments and functional tasks and features in the network. Each module or circuit may comprise a processor (e.g., 222 or 232) together with corresponding program instructions. In one example, UE 201 performs NAS layer registration and enters 5GMM connected mode in NAS layer through its serving base station. Later on, the UE performs a handover or inter-system change procedure and receives NASC IE from the network. Upon detecting the NASC verification failure, the UE aborts the handover or the inter-system change procedure. The UE goes back to 5GMM idle mode and sends a REGISTRATION REQUEST message to establish new NAS security context for mobility and to re-synchronize with the network.

The source to target NAS transparent container IE is an information element that is used to transparently pass radio related information from the handover source to the handover target. The purpose of the NAS transparent container IE is to provide the UE with parameters that enable the UE to handle the 5G NAS security context after N1 mode to N1 mode handover, or to provide the UE with parameters that enable the UE to create a mapped 5G NAS security context and take this context into use after inter-system change from S1 mode to N1 mode in 5GMM-connected mode. The content of the NASC IE is included in specific information elements within some RRC messages sent to the UE, e.g., a mobility command. N1 mode is a mode of UE allowing access to the 5G core network via the 5G access network, while S1 mode is a mode of UE allowing access to the 4G core network via the 4G access network. Mobility refers to both intra N1 mode handover and inter-system change between S1 mode and N1 mode.

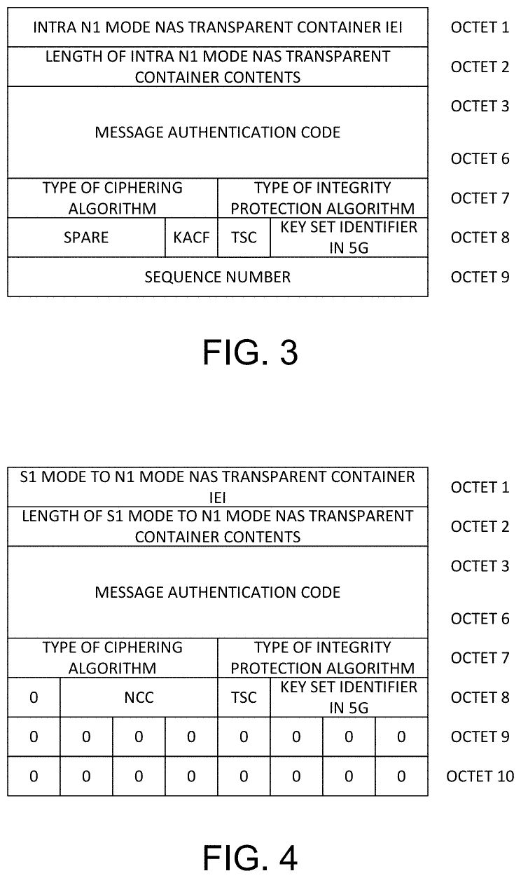

FIG. 3 illustrates an example of intra N1 mode NAS transparent container information element (NASC IE) provided by network in intra N1 mode handover. The purpose of the NAS transparent container IE is to provide the UE with parameters that enable the UE to handle the 5G NAS security context after N1 mode to N1 mode handover. Type of integrity protection algorithm and type of ciphering algorithm are codes in the NAS security algorithm IE. The K_AMF_change_flag (KACF) bit, if 0 indicates a new K_{AMF} has not been calculated by the network, if 1 indicates a new K_{AMF} has been calculated by the network. Key set identifier in 5G and Type of security context flag (TSC) are coded as the NAS key set identifier and type of security context flag in the NAS key set identifier IE.

FIG. 4 illustrates an example of S1 mode to N1 mode NAS transparent container information element (NASC IE) provided by network in inter-system change. The purpose of the NAS transparent container IE is to provide the UE with parameters that enable the UE to create a mapped 5G NAS security context and take this context into use after inter-system change from S1 mode to N1 mode in 5GMM-connected mode. Type of integrity protection algorithm and type of ciphering algorithm are codes in the NAS security algorithm IE. NCC contains the 3-bit next hop chaining counter. Key set identifier in 5G and Type of security context flag (TSC) are coded as the NAS key set identifier and type of security context flag in the NAS key set identifier IE.

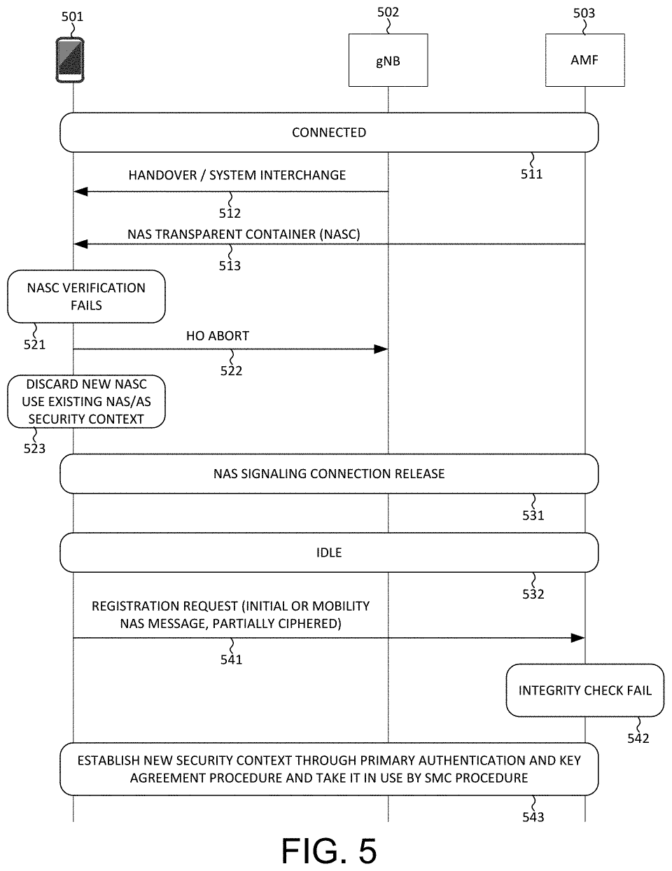

FIG. 5 illustrates a first embodiment of a method for NAS recovering from NASC failure in a next generation 5G system in accordance with embodiments of the current invention. In step 511, UE 501 registers to the network and establishes a NAS signaling connection and an RRC signaling connection via its serving base station gNB 502 and AMF 503. In AS layer, UE 501 is in RRC-connected mode with gNB 502. In NAS layer, UE 501 is in 5GMM-connected mode with AMF 503. The established NAS signaling connection is associated with a NAS security context, which comprises at least one of a NAS security keys and a NAS algorithm for protecting NAS signaling messages delivered over the established NAS signaling connection. In step 512, UE 501 receives a mobility command from gNB 502, e.g., an intra N1 mode handover command or an inter-system change command, from serving gNB 502. In step 513, UE 501 receives a NAS transparent container (NASC) from AMF 503. The NASC could be delivered to UE 501 via gNB 502 over the established RRC signaling connection.

In one example, if UE receives a NASC in the HO Command message, the UE shall update its NAS security context as follows. The UE shall verify the freshness of the downlink NAS COUNT in the NASC. If the NASC indicates a new K_{AMF} has been calculated (i.e., KACF is set to one), the UE shall compute the horizontally derived K_{AMF} using the K_{AMF} from the current 5G NAS security context identified by the ngKSI included in the NASC and the downlink NAS COUNT in the NASC. The UE shall assign the ngKSI included in the NASC to the ngKSI of the new derived K_{AMF}. The UE shall further configure NAS security based on the horizontally derived K_{AMF} and the selected NAS security algorithms in the NASC. The UE shall further verify the NAS MAC in the NASC. If the verification is successful, the UE shall further set the NAS COUNT to zero.

In another example, during inter-system change from S1 mode to N1 mode, the AMF shall select the 5G NAS security algorithms and derive the 5G NAS keys (i.e. K_{NASenc} and K_{NASint}). The AMF shall define an ngKSI for the newly derived K′_{AMF} key such that the value field is taken from the eKSI of the K_{ASME} key and the type field is set to indicate a mapped security context and associate this ngKSI with the newly created mapped 5G NAS security context. The AMF shall then include the message authentication code, selected NAS algorithms, NCC, NAS sequence number, replayed UE security capabilities and generated ngKSI in the S1 mode to N1 mode NASC. When the UE operating in single-registration mode receives the command to perform inter-system change to N1 mode in 5GMM-CONNECTED mode, the UE shall derive a mapped K′_{AMF}, using the K′_{ASME} from the EPS security context. Furthermore, the UE shall derive the 5G NAS keys from the mapped K′_{AMF} using the selected NAS algorithm identifiers included in the S1 mode to N1 mode NASC IE and associate this mapped 5G NAS security context with the ngKSI value received. The UE shall verify the received NAS MAC in the NASC.

In step 521, UE 501 detects that NASC verification fails. In step 522, UE 501 aborts the handover procedure. In step 523, UE 501 discards security context created through the NASC based security mode command (SMC) procedure, and uses the existing NAS/AS layer security context. However, the UE and the network security context can be out of sync due to the NASC verification failure. As a result, subsequent communication fails because integrity check fails. In accordance with one novel aspect of the present invention, in step 531, UE 501 release the NAS signaling connection. In step 532, UE 501 goes to RRC-idle mode and 5GMM-idle mode. In step 541, UE 501 triggers a registration procedure by sending a registration request to AMF 503. The registration request can be either for initial or mobility registration. In one embodiment, UE 501 keeps its previous CURRENT security context. For mobility registration updating, the INITIAL NAS message is partially protected with CURRENT security context that is not in sync with the network. In step 542, the partially protected initial NAS message NAS MAC integrity check fail, which triggers Authentication and SMC procedure. In step 543, AMF 503 will trigger the Authentication and SMC procedure to create a new security context. UE 501 then establishes the new NAS security context through primary authentication and key agreement procedure and uses in the SMC procedure. The UE and the network NAS security context become re-synchronized for subsequent communication after the registration procedure.

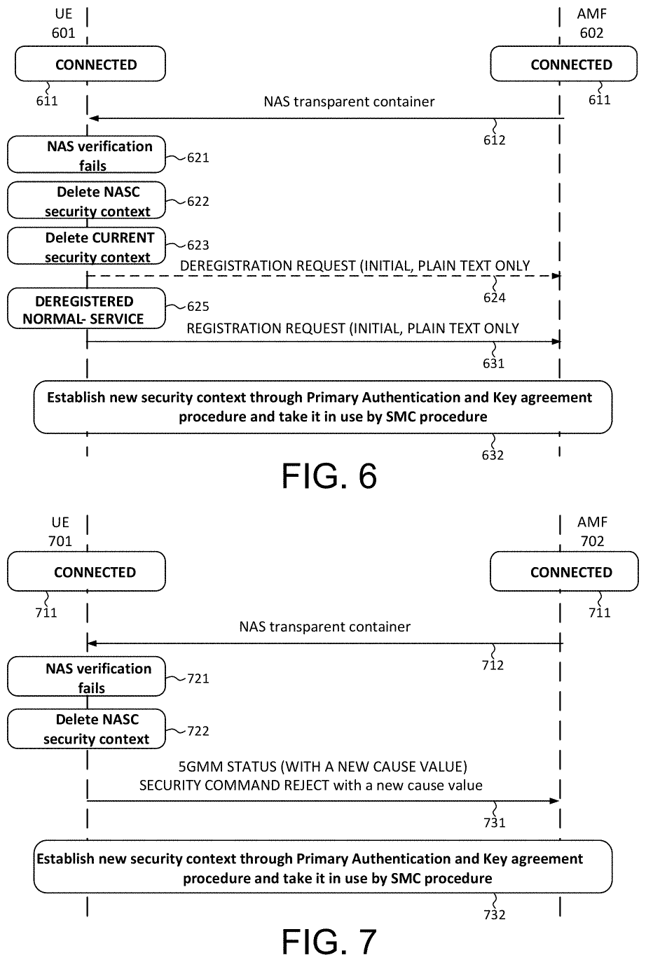

FIG. 6 illustrates a second embodiment of a method for NAS recovering from NASC failure in a next generation 5G system in accordance with embodiments of the current invention. In step 611, UE 601 establishes a NAS signaling connection with AMF 602 and goes to 5GMM-connected mode in NAS layer. The established NAS signaling connection is associated with a NAS security context, which comprises at least one of a NAS security keys and a NAS algorithm for protecting NAS signaling messages delivered over the established NAS signaling connection. In step 612, UE 601 receives a NAS transparent container (NASC) from AMF 602. The NASC could be delivered to UE 601 via a serving base station over an established RRC signaling connection, e.g., through an intra N1 mode handover command or an inter-system change command from the serving base station. In one example, the NASC comprises at least one of a NAS count, a NAS MAC, a NAS algorithm, and an indication of a change in a NAS security key.

In step 621, UE 601 detects that NASC verification fails. In step 622, UE 601 delete security context created through the NASC-based SMC procedure. However, the UE and the network security context can be out of sync due to the NASC verification failure. As a result, subsequent communication fails because integrity check fails. In accordance with one novel aspect of the present invention, in step 623, UE 601 deletes the CURRENT security context. In step 624, UE 601 sends a deregistration request message to AMF 602. The request is an initial NAS message with plain text only. Note that this step of deregistration is optional. In step 625, UE 601 enters deregistered normal service. In step 631, UE 601 triggers a registration procedure by sending a registration request to AMF 602. The registration request is an initial NAS message with plain text only. In step 632, Authentication and SMC procedure is triggered to create new security context, as the initial registration request does not have indicated security context. UE 601 thus establishes new NAS security context through primary authentication and key agreement procedure. The UE and the network NAS security context become re-synchronized.

FIG. 7 illustrates a third embodiment of a method for NAS recovering from NASC failure in a next generation 5G system in accordance with embodiments of the current invention. In step 711, UE 701 establishes a NAS signaling connection with AMF 702 and goes to 5GMM-connected mode in NAS layer. The established NAS signaling connection is associated with a NAS security context, which comprises at least one of a NAS security keys and a NAS algorithm for protecting NAS signaling messages delivered over the established NAS signaling connection. In step 712, UE 701 receives a NAS transparent container (NASC) from AMF 702. The NASC could be delivered to UE 701 via a serving base station over an established RRC signaling connection, e.g., through an intra N1 mode handover command or an inter-system change command from the serving base station. In one example, the NASC comprises at least one of a NAS count, a NAS MAC, a NAS algorithm, and an indication of a change in a NAS security key.

In step 721, UE 701 detects that NASC verification fails. In step 722, UE 701 delete security context created through the NASC-based SMC procedure. However, the UE and the network security context can be out of sync due to the NASC verification failure. As a result, subsequent communication fails because integrity check fails. In accordance with one novel aspect of the present invention, in step 731, UE 701 sends a 5GMM status with a new cause value indicating the NASC verification failure. Alternatively, UE 701 sends a Security Command Reject message to AMF 702. In step 732, Authentication and SMC are triggered by the 5GMM status to create and take in new security context. Alternatively, Authentication and SMC are triggered by the Security Mode Reject to create and take in new security context. UE 701 thus establishes new NAS security context through primary authentication and key agreement procedure. The UE and the network NAS security context become re-synchronized.

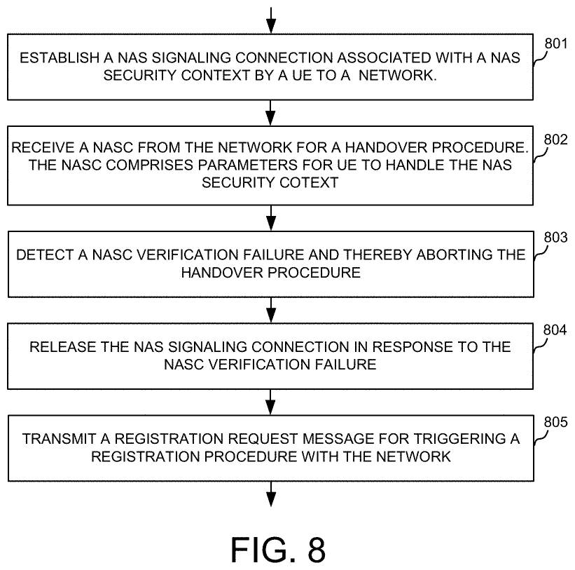

FIG. 8 is a flow chart of a method for NAS recovering from NASC failure in a next generation 5G system in accordance with a novel aspect. In step 801, a UE establishes a non-access stratum (NAS) signaling connection associated with a NAS security context to a network. In step 802, the UE receives a NAS container (NASC) from the network for a handover procedure. The NASC comprises parameters for UE to handle the NAS security context. In step 803, the UE detects a NASC verification failure and thereby aborting the handover procedure. In step 804, the UE releases the NAS signaling connection in response to the NASC verification failure. In step 805, the UE transmits a registration request message for triggering a registration procedure with the network.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
establishing a non-access stratum (NAS) signaling connection associated with a NAS security context by a user equipment (UE) to a network;
receiving a NAS container (NASC) from the network for a handover procedure, wherein the NASC comprises parameters for UE to handle the NAS security context;
detecting a NASC verification failure and thereby aborting the handover procedure;
releasing the NAS signaling connection in response to the NASC verification failure; and
transmitting a registration request message for triggering a registration procedure with the network.

2. The method of claim 1, wherein the NAS security context comprises at least one of a NAS security key and a NAS algorithm for protecting NAS signaling messages delivered over the established NAS signaling connection.

3. The method of claim 1, wherein the NASC comprises at least one of a NAS count, a NAS MAC, a NAS algorithm, and an indication of a change in a NAS security key.

4. The method of claim 3, wherein the UE updates the NAS security context based on the received NASC.

5. The method of claim 3, wherein the NASC verification failure involves NAS MAC verification failure.

6. The method of claim 1, wherein the UE discard any new derived NAS security context based on the received NASC and continue to use the current NAS security context upon the NASC verification failure.

7. The method of claim 1, wherein the registration request is an initial request or a mobility request.

8. The method of claim 7, further comprising:
using a new NAS security context after transmitting the registration request message.

9. The method of claim 8, further comprising:
establishing the new NAS security context through a primary authentication and key agreement procedure.

10. The method of claim 1, wherein the handover is an intra N1 mode handover or an inter-system change from S1 mode to N1 mode.

11. A User Equipment (UE), comprising:
a connection handling circuit that establishes a non-access stratum (NAS) signaling connection associated with a NAS security context to a network;
a receiver that receives a NAS container (NASC) from the network for a handover procedure, wherein the NASC comprises parameters for UE to handle the NAS security context;
a handover handling circuit that detects a NASC verification failure and thereby aborting the handover procedure, wherein the UE releases the NAS signaling connection in response to the NASC verification failure; and
a transmitter that transmits a registration request message for triggering a registration procedure with the network.

12. The UE of claim 11, wherein the NAS security context comprises at least one of a NAS security key and a NAS algorithm for protecting NAS signaling messages delivered over the established NAS signaling connection.

13. The UE of claim 11, wherein the NASC comprises at least one of a NAS count, a NAS MAC, a NAS algorithm, and an indication of a change in a NAS security key.

14. The UE of claim 13, wherein the UE updates the NAS security context based on the received NASC.

15. The UE of claim 13, wherein the NASC verification failure involves NAS MAC verification failure.

16. The UE of claim 11, wherein the UE discard any new derived NAS security context based on the received NASC and continue to use the current NAS security context upon the NASC verification failure.

17. The UE of claim 11, wherein the registration request is an initial request or a mobility request.

18. The UE of claim 17, wherein a new NAS security context is used after the UE transmitting the registration request message.

19. The UE of claim 18, wherein the new NAS security context is established through a primary authentication and key agreement procedure.

20. The UE of claim 11, wherein the handover is an intra N1 mode handover or an inter-system change from S1 mode to N1 mode.
